(19) United States
(12) Patent Application Publication
(10) Pub. No.: US 2012/0299860 A1
(43) Pub. Date: Nov. 29, 2012

(54) USER INPUT

(75) Inventors: Wei Wang, Beijing (CN); Kongqiao Wang, Beijing (CN); Xiaohui Xie, Beijing (CN); Yingfei Liu, Beijing (CN); Xia Wang, Beijing (CN); Huanglingzi Liu, Beijing (CN); Bin Wang, Shanghai (CN); Zhen Liu, Tarrytown, NY (US); Yuezhong Tang, Beijing (CN)

(73) Assignee: NOKIA CORPORATION, Espoo (FI)

(21) Appl. No.: 13/576,234

(22) PCT Filed: Feb. 4, 2010
(86) PCT No.: PCT/CN2010/070509

§ 371 Date: Jul. 31, 2012

(51) Int. Cl. G06F 3/041

(52) U.S. Cl. 345/173

(57) ABSTRACT

An apparatus, a method and a computer program is provided. The apparatus comprises at least one processor; and at least one memory storing computer program instructions, the at least one processor being configured to execute the computer program instructions to cause the apparatus at least to perform: processing an input pattern, detected at an instance in time by a touch sensitive display, to discriminate between a fingertip input pattern and an elongate input pattern; performing a first action after discriminating that the input pattern corresponds with the fingertip input pattern; and performing a second action after discriminating that the input pattern corresponds with the elongate input pattern, wherein the second action is different to the first action.

### FIELD

Embodiments of the present invention relate to user input. In particular, they relate to processing input patterns detected by a touch sensitive display device.

### BACKGROUND

Some electronic devices, such as mobile telephones, include a touch sensitive display. Typically, a user provides input by touching the touch sensitive display with a fingertip. For example, a user may navigate through a menu by selecting graphical items using a fingertip.

### BRIEF DESCRIPTION OF VARIOUS EXEMPLARY EMBODIMENTS OF THE INVENTION

According to some, but not necessarily all, embodiments of the invention, there is provided an apparatus, comprising: at least one processor; and at least one memory storing computer program instructions, the at least one processor being configured to execute the computer program instructions to cause the apparatus at least to perform: processing an input pattern, detected at an instance in time by a touch sensitive display, to discriminate between a fingertip input pattern and an elongate input pattern; performing a first action after discriminating that the input pattern corresponds with the fingertip input pattern; and performing a second action after discriminating that the input pattern corresponds with the elongate input pattern, wherein the second action is different to the first action.

According to some, but not necessarily all, embodiments of the invention, there is provided a method, comprising: processing an input pattern, detected at an instance in time by a touch sensitive display, to discriminate between a fingertip input pattern and an elongate input pattern; performing a first action after discriminating that the input pattern corresponds with the fingertip input pattern; and performing a second action after discriminating that the input pattern corresponds with the elongate input pattern, wherein the second action is different to the first action.

According to some, but not necessarily all, embodiments of the invention, there is provided a computer program comprising computer program instructions that, when executed by at least one processor, cause an apparatus at least to perform: processing an input pattern, detected at an instance in time by a touch sensitive display, to discriminate between a fingertip input pattern and an elongate input pattern; performing a first action after discriminating that the input pattern corresponds with the fingertip input pattern; and performing a second action after discriminating that the input pattern corresponds with the elongate input pattern, wherein the second action is different to the first action.

According to some, but not necessarily all, embodiments of the invention, there is provided an apparatus, comprising: means for processing an input pattern, detected at an instance in time by a touch sensitive display, to discriminate between a fingertip input pattern and an elongate input pattern; means for performing a first action after discriminating that the input pattern corresponds with the fingertip input pattern; and means for performing a second action after discriminating that the input pattern corresponds with the elongate input pattern, wherein the second action is different to the first action.

### BRIEF DESCRIPTION OF THE DRAWINGS

For a better understanding of various examples of embodiments of the present invention reference will now be made by way of example only to the accompanying drawings in which:

FIG. 1 illustrates an apparatus;

FIG. 2 illustrates a further apparatus;

FIG. 3 illustrates the palmar surface of a hand;

FIG. 4 illustrates the dorsal surface of a hand;

FIG. 5 illustrates a side edge of a hand;

FIGS. 6A and 6B illustrate providing input using a fingertip;

FIGS. 7A to 7D illustrates providing input using a side edge of a hand;

FIG. 8 illustrates a side edge of a hand at an apparatus;

FIG. 9A illustrates a fingertip input pattern;

FIG. 9B illustrates an elongate input pattern;

FIG. 9C illustrates another elongate input pattern;

FIG. 9D illustrates a further elongate input pattern; and

FIG. 10 illustrates a flow diagram of a method.

### DETAILED DESCRIPTION OF VARIOUS EXEMPLARY EMBODIMENTS OF THE INVENTION

Embodiments of the invention relate to processing input patterns detected by a touch sensitive input display. In particular, they relate to discriminating between an input provided at the touch sensitive display using a fingertip and input provided at the touch sensitive display using a side edge of a hand.

The Figures illustrate an apparatus 10/30, comprising: at least one processor 12; and at least one memory 14 storing computer program instructions 18, the at least one processor 12 being configured to execute the computer program instructions 18 to cause the apparatus 10/30 at least to perform: processing an input pattern, detected at an instance in time by a touch sensitive display 22, to discriminate between a fingertip input pattern 80 and an elongate input pattern 90/90a/90c; performing a first action after discriminating that the input pattern corresponds with the fingertip input pattern 80; and performing a second action after discriminating that the input pattern corresponds with the elongate input pattern 90/90a/90c, wherein the second action is different to the first action.

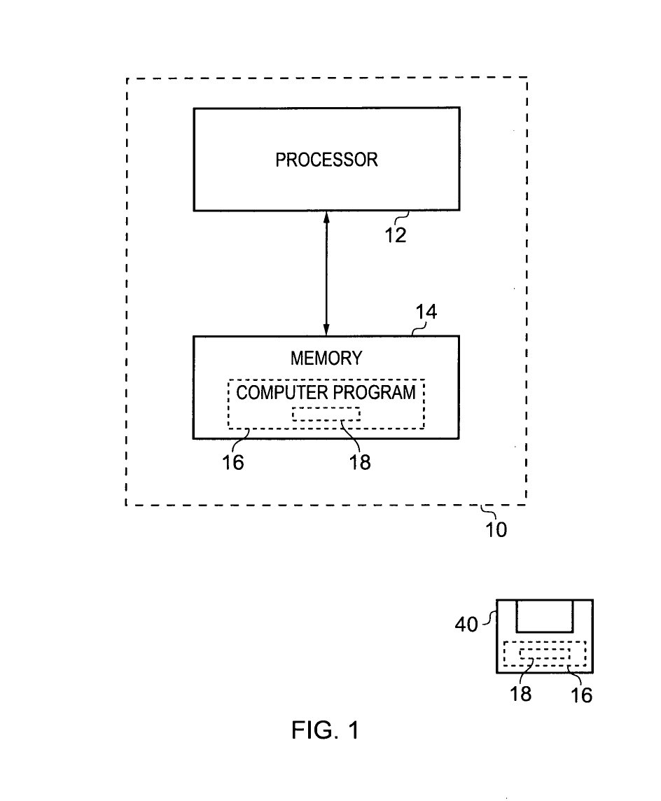

FIG. 1 illustrates an apparatus 10. The apparatus 10 may, for example, be a chip or a chip-set. The apparatus 10 illustrated in FIG. 1 comprises a processor 12 and a memory 14. In alternative embodiments of the invention, the apparatus 10 may comprise multiple processors.

The processor 12 is configured to read from and write to the memory 14. The processor 12 may also comprise an output interface via which data and/or commands are output by the processor 12 and an input interface via which data and/or commands are input to the processor 12.

Although the memory 14 is illustrated as a single component it may be implemented as one or more separate components, some or all of which may be integrated/removable and/or may provide permanent/semi-permanent/dynamic/cached storage.

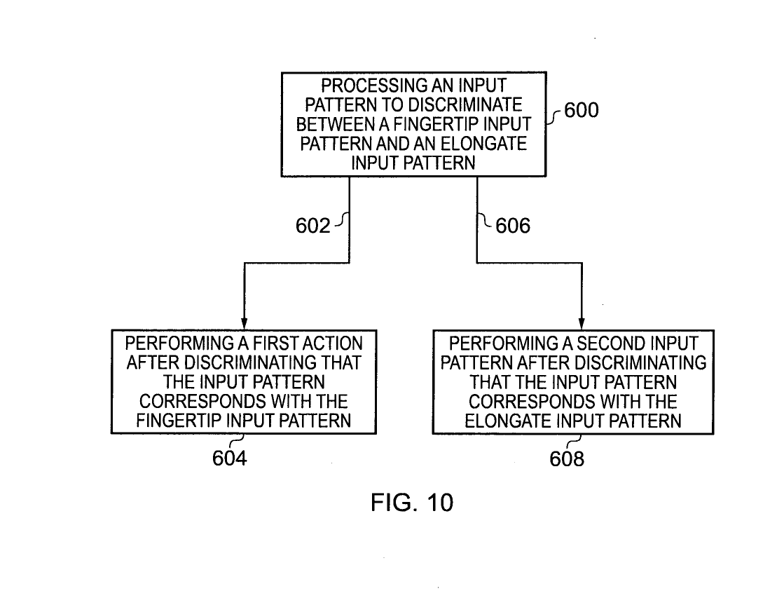

The memory 14 stores a computer program 16 comprising computer program instructions 18 that control the operation of the apparatus 10/30 when loaded into the processor 12. The computer program instructions 18 provide the logic and routines that enables the apparatus 10/30 to perform the method illustrated in FIG. 10. The processor 12 by reading the memory 14 is able to load and execute the computer program instructions 18.

The computer program 16 may arrive at the apparatus 10/30 via any suitable delivery mechanism 40. The delivery mechanism 40 may be, for example, a tangible computer-readable storage medium, a computer program product, a memory device, a record medium such as a CD-ROM, DVD or Blu-Ray disc, or any article of manufacture that tangibly embodies the computer program 16. The delivery mechanism 40 may be a signal configured to reliably transfer the computer program 16.

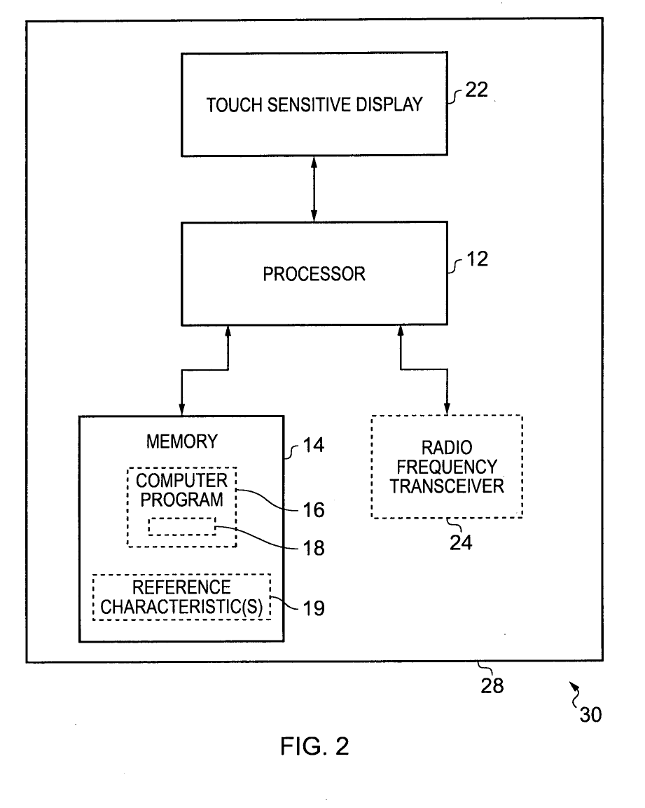

FIG. 2 illustrates a further apparatus 30. The apparatus 30 illustrated in FIG. 2 may, for example, be a hand portable electronic device such as a mobile telephone, a personal music player, a personal digital assistant or a camera.

The apparatus 30 illustrated in FIG. 2 comprises the apparatus 10 illustrated in FIG. 1. The apparatus 30 further comprises a housing 28, a touch sensitive display 22 and optionally, a radio frequency transceiver 24. The housing 28 houses: the processor 12, the memory 14, the touch sensitive display 22 and the radio frequency transceiver 24. The elements 12, 14, 22 and 24 are co-located within the housing 28. The elements 12, 14, 22 and 24 are operationally coupled and any number or combination of intervening elements can exist (including no intervening elements).

The processor 12 is configured to provide outputs to the touch sensitive display 22 and the radio frequency transceiver 24. The processor 12 is configured to receive inputs from the radio frequency transceiver 24 and the touch sensitive display 22.

The memory 14 in FIG. 2 is illustrated as storing at least one reference characteristic 19. The function of the reference characteristic(s) 19 will be described in further detail below, in reference to FIG. 10.

The touch sensitive display 22 is configured to provide a graphical user interface. The touch sensitive display 22 may be any type of touch sensitive display, such as a resistive touch sensitive display or a capacitive touch sensitive display. The touch sensitive display 22 may be configured to detect multiple (spatially separate) touch inputs simultaneously.

The radio frequency transceiver 24 is configured to transmit and receive radio frequency signals. The radio frequency transceiver 24 may, for example, be a cellular transceiver that is compatible with one or more cellular protocols such as GSM (Global System for Mobile Communications), IS-95 (Interim Standard 95) or UMTS (Universal Mobile Telecommunications System). Alternatively, the radio frequency transceiver 24 may be a short range transceiver that is compatible with one or more short range protocols, such as Bluetooth protocols or IEEE (Institute of Electrical and Electronic Engineers) protocols. In some embodiments of the invention, the apparatus 30 comprises one or more cellular transceivers and one or more short range transceivers.

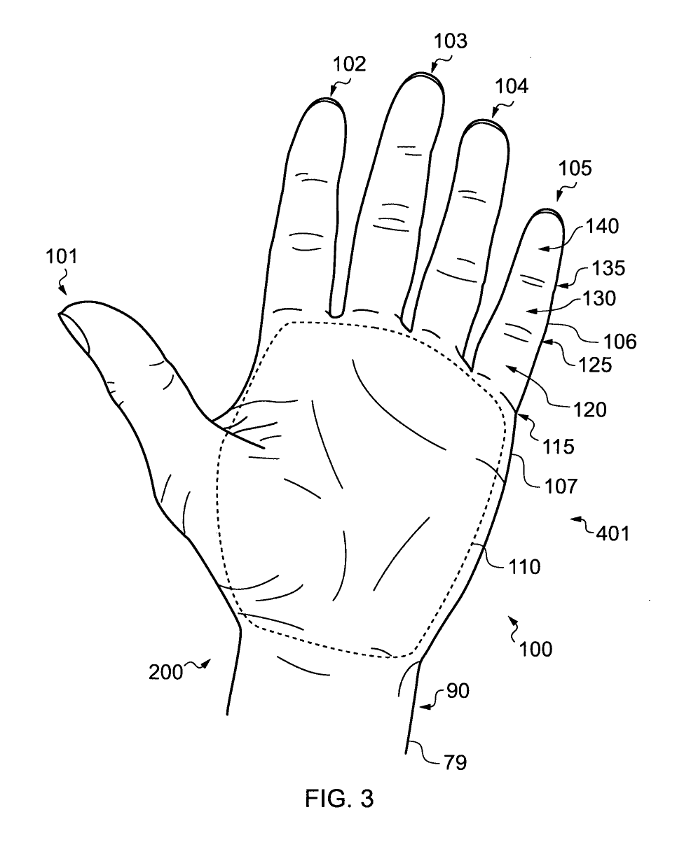

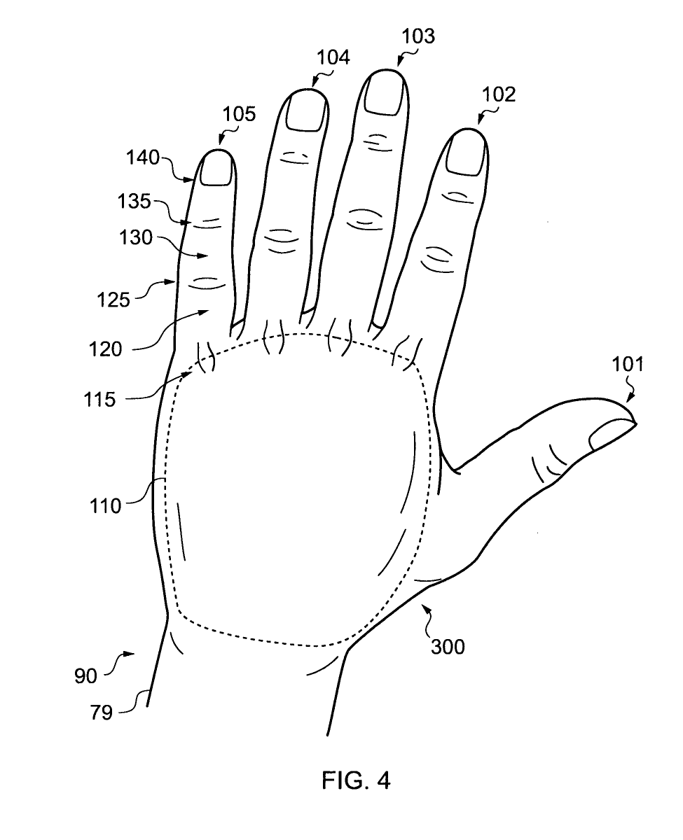

FIG. 3 illustrates the palmar surface 200 of a hand 100 when the hand 100 is in an open configuration. FIG. 4 illustrates the dorsal surface 300 of a hand 100 when the hand 100 is in an open configuration.

The hand 100 is connected to an arm 79 by a wrist 90. The hand 100 comprises a thumb 101 and four fingers 101-105. The first finger 102 from the thumb 101 is known as the “index finger”. The second finger 103 from the thumb 101 is known as the “middle finger”. The third finger 104 from the thumb 101 is known as the “ring finger”. The fourth finger 105 from the thumb 101 is known as the “little finger”.

The area of the hand 100 designated by the dotted fine 110 includes the metacarpal bones. Consequently, this region will be referred to as the “metacarpal region 110”.

Each finger 101-105 includes three separate bones: the proximal phalanx 120, the intermediate phalanx 130 and the distal phalanx 140. The proximal phalanx 120 is connected to the metacarpal region 110 by the metacarpophalangeal joint 115. The intermediate phalanx 130 is connected to the proximal phalanx 120 by the proximal interphalangeal joint 125. The distal phalanx 140 is connected to the proximal phalanx by the distal interphalangeal joint 135. The reference numerals 115, 120, 125, 130, 135 and 140 are only illustrated in relation to the little finger 105 in FIGS. 3 and 4 for clarity reasons.

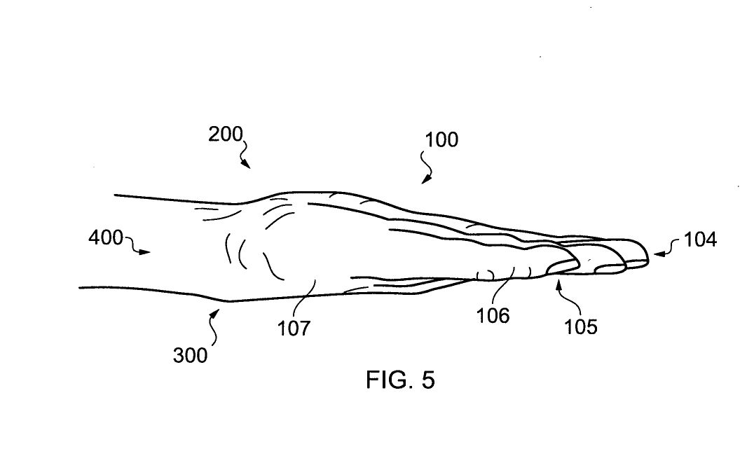

FIG. 5 illustrates a side edge 400 of a hand 100. The viewpoint illustrated in FIG. 5 is indicated by the arrow 401 in FIG. 3. The side edge 400 includes first and second side surfaces 107, 106 that conjoin the palmar surface 200 and the dorsal surface 300 of the hand 100.

The first side surface 107 is a portion of the metacarpal region 110 of the hand. The first side surface 107 is on the opposite side of the metacarpal region 110 to the thumb 101. The second side surface 106 is a portion of the little finger 105 of the hand 100. The second side surface 106 is on the opposite side of the little finger 105 to the ring finger 104.

The length of the hand 100 can be considered to be substantially aligned with the direction of the fingers 102-105 in FIGS. 3 and 4. The length of the hand 100 is defined by the fingers 102-105 and the metacarpal region 110. The width of the hand 100 can be considered to be substantially perpendicular to the length. The width of the hand 100 is defined by the metacarpal region 110 and the thumb 101. The side edge 400 defines the depth of the hand. The side edge 400 of the hand 100 can be considered to be approximately perpendicular to the palmar and dorsal surfaces 200, 300 of the hand 100 when the hand 100 is in an open configuration.

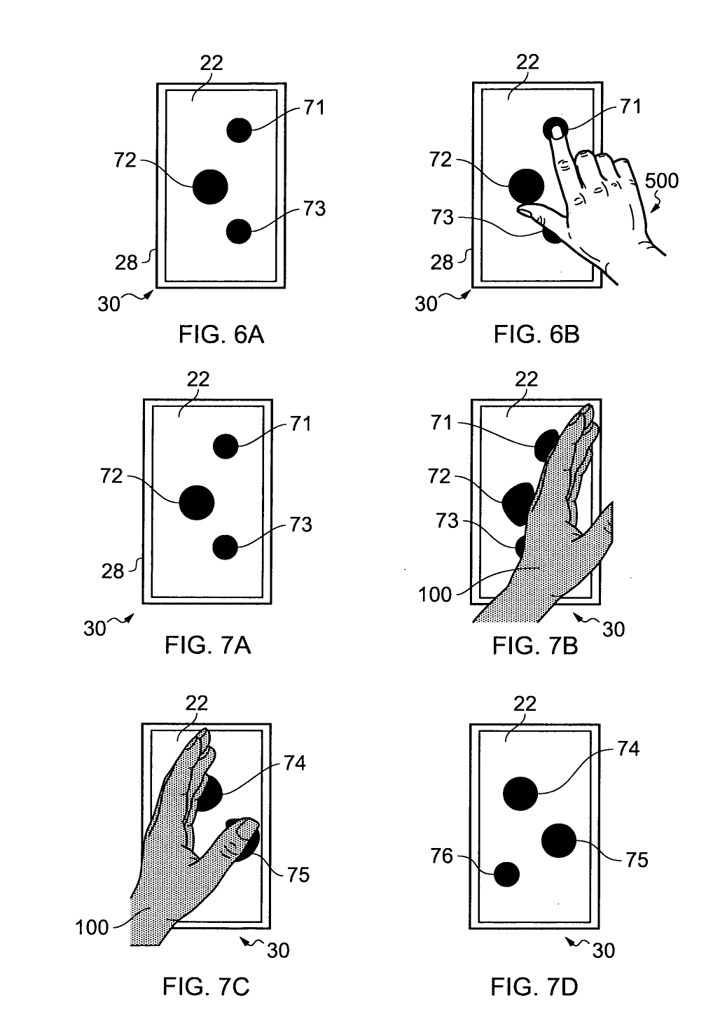

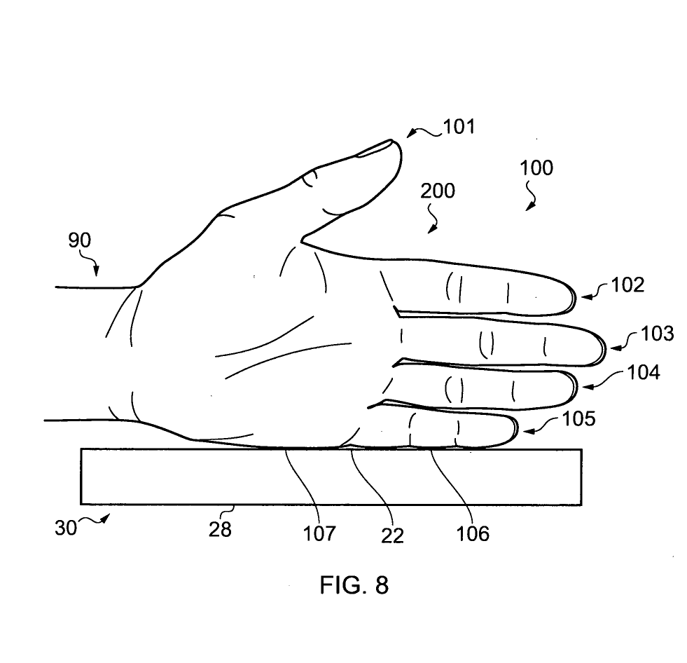

FIGS. 6A to 7D illustrate the apparatus 30 of FIG. 3 and the touch sensitive display 22. When a user touches the touch sensitive display 22 (for instance, directly or indirectly with a stylus), the touch sensitive display 22 responds by detecting an input pattern. The input pattern depends upon which area(s) of the display 22 are touched by a user at a particular instance in time. The size and shape of the input pattern reflects the contact that the user makes with the touch sensitive display 22 when he touches it. The touch sensitive display 22 is configured to provide detected input patterns to the processor 12.

The processor 12 may control the touch sensitive display 22 to display content. In FIG. 6A, the displayed content takes the form of one or more graphical items 71-73. FIG. 6A illustrates the touch sensitive display 22 displaying the first, second and third graphical items 71-73. The graphical items 71-73 may, for example, be individually selectable. That is, one graphical item 71-73 is selectable without selecting the other displayed graphical items 71-73.

FIGS. 6A and 6B relate to detecting fingertip input at the touch sensitive display 22. In this example, a user may select a displayed graphical item 71-73 by providing fingertip input at the position of that graphical item 71-73. FIG. 6B illustrates a user selecting the first graphical item 71 by touching it with his index finger.

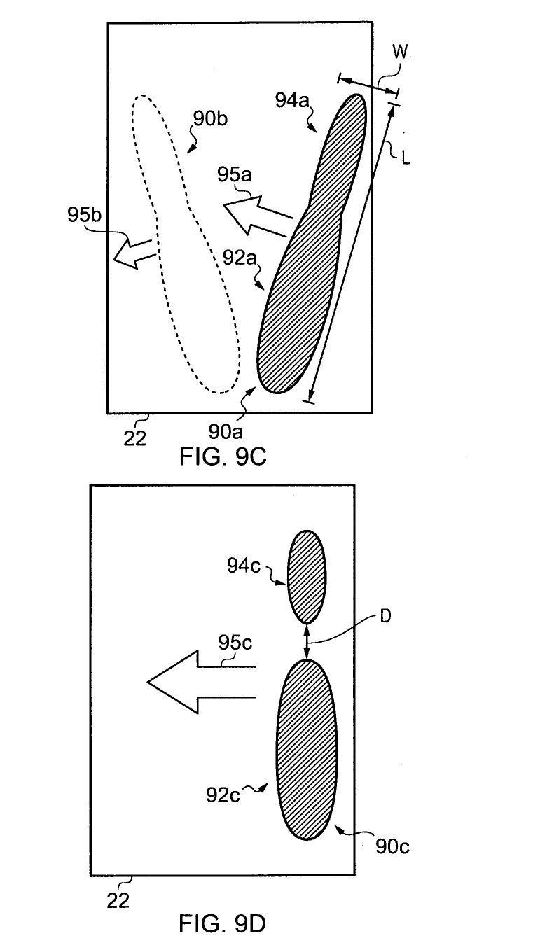

FIG. 9A illustrates the input pattern 80 that is detected by the touch sensitive display 22 when the user touches the display 22 with a fingertip. This “fingertip input pattern” 80 is substantially the same size and shape as a fingertip.

In FIG. 6B, the user touches the display 22, with a fingertip, at the position of the first graphical item 71. The processor 12 determines that the touch sensitive display 22 has detected a fingertip input pattern 80 at the first graphical item 71, and interprets it as selection of the first graphical item 71.

The graphical items 71-73 may, for instance, be menu items in a hierarchical menu. For example, the graphical items 71-73 may be items in a first level of the hierarchical menu, and selection of one of the graphical items 71-73 may cause the processor 12 to display one or more further graphical items. The further graphical items are at a second (lower) level in the hierarchical menu.

For instance, consider an example in which the first graphical item 71 relates to “messaging”, the second graphical item 72 relates to “contacts” and the third graphical item 73 relates to “settings”. Selection of the first graphical item 71 may cause the processor 12 to remove the second and third graphical items 72, 73 from display, and to display one or more further graphical items relating to an “inbox”, “sent items”, “drafts”, etc. The inbox, sent items and drafts may be accessed by selecting the relevant graphical item.

FIGS. 7A to 7D relate to detecting user input provided using the side edge 400 of a hand 100. In this example, user input using the side edge 400 of a hand 100 is an alternative form of user input that is interpreted by the processor 12 differently from fingertip input.

FIG. 7A is the same as FIG. 6A and illustrates the touch sensitive display 22 displaying a plurality of graphical items 71-73.

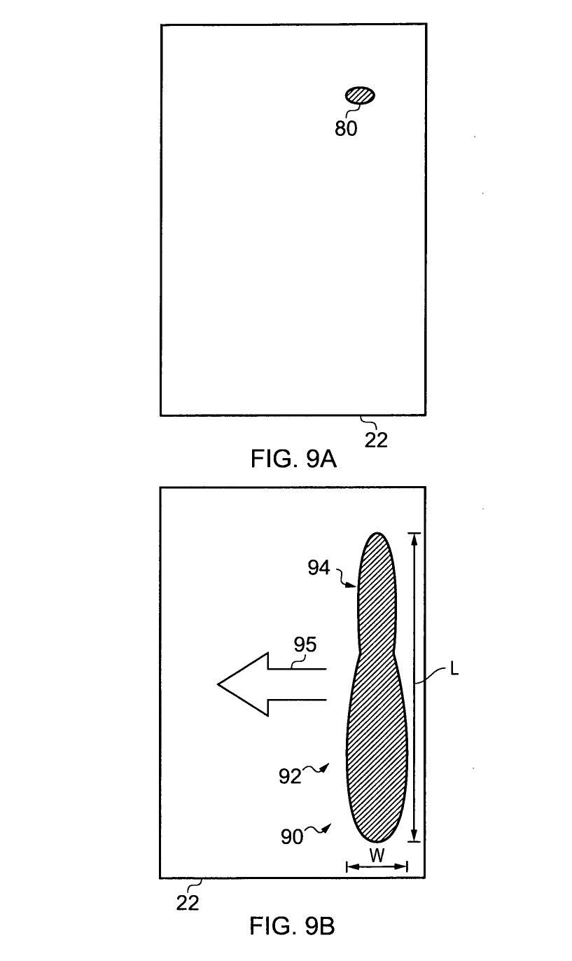

In FIG. 7B, the user places the side edge 400 of his hand 100 towards the right hand side of the touch sensitive display 22. This is also illustrated in FIG. 8. It can be seen in FIG. 8 that, in this example, the side surface 107 of the metacarpal region 110 of the hand 100 and the side surface 106 of the little finger 105 are placed against the display 22.

Once the user has placed the side edge 400 of his hand 100 on the display 22, he moves it across the display 22. In this example, the user places his hand on the right hand side of the display 22 and then he moves his hand to the left, such that the dorsal surface 300 of the hand 100 is the leading surface of the movement.

The side edge of the hand 100 remains in contact with the display 22 as the hand 100 moves across the display 22. The movement of the hand 100 may, for example, be caused by rotating the wrist, the elbow and/or the shoulder. FIG. 7C illustrates the hand 100 when it has moved partially across the display 22.

The gesture that is illustrated in FIGS. 7B, 7C and 8 can be thought of as a sweeping or wiping gesture in which the hand 100 is held as a blade (that is, in a substantially open configuration, as illustrated in FIG. 8) as the side edge 400 of the hand 100 is wiped across the display 22.

FIG. 9B illustrates the input pattern 90 that is detected by the touch sensitive display 22 when the user places the side edge 400 of his hand 100 on the display 22. The input pattern is spatially elongate, because the side edge 400 of the hand 100 that is placed at the display 22 is spatially elongate.

The elongate input pattern 90 has a length L and a width W. The length L is larger than the width W. For example, the length L may be: i) more than two times larger than the width W, ii) more than three times larger than the width W, or iii) more than four times larger than the width W.

The elongate input pattern 90 comprises a first elongate portion 94 and a second elongate portion 92. The first elongate portion 94 is produced due to the input provided by the side surface 106 of the little finger 105. The second elongate portion 92 is produced due to the input provided by the side surface 107 of the metacarpal region 110 of the hand 100.

In this example, the side surface 107 of the metacarpal region 110 of the hand 100 has a larger width than the side surface 106 of the little finger 105. Consequently, the width of the second elongate portion 92 is larger than the width of the first elongate portion 94.

Movement of the side edge 400 of the hand 100 across the display 22 causes the elongate input pattern 90 to move across the display 22. The arrow 95 in FIG. 9B illustrates the direction of movement of the elongate input pattern 90. The direction of movement of the elongate input pattern 90 is substantially perpendicular to the length L of the elongate input pattern 90 and substantially parallel to the width W of the elongate input pattern 90.

In this example, the hand 100 is moved by rotating the elbow and/or the shoulder, so the length of the elongate input pattern 90 remains substantially aligned with the length of the display 22 during movement. The direction of movement of the elongate input pattern 90 is substantially perpendicular to the width of the display 22 in this example.

The display 22 may respond to movement of the side edge 400 of the hand 100 by detecting the elongate input pattern 90 at various positions on the display 22 at particular instances in time, over a period of time. The processor 12 may be configured to determine that the elongate input pattern 90 is moving (and to determine the direction of movement) by analyzing the location of the elongate input pattern 90 on the display 22 over a period of time. For example, the processor 12 may ascertain that the elongate input pattern 90 is moving by determining that the elongate input pattern 90 is at different positions on the display 22 at different instances in time. In the example illustrated in FIGS. 7A to 7D, the hand 100 (and therefore the elongate input pattern 90) moves across the graphical items 71-73 displayed on the display 22.

After the processor 12 determines that an elongate input pattern 90 is moving across the display 22, it controls the display 22 to display another plurality of graphical items 74-76. The graphical items 74-76 are different to the graphical items 71-73 displayed on the display 22 in FIG. 7A (prior to the hand swipe by the user) and may, for example, be menu items that are at the same level in the hierarchical menu structure as the graphical items 71-73. The graphical items 74-76 are different to those displayed when one of the graphical items 71-73 is selected.

Thus, in this example, the hand swipe by the user does not result in selection of any of the graphical items 71-73 originally displayed on the display 22 (in FIG. 7A), but instead results in graphical items 74-76 at the same level in the hierarchical menu structure being displayed on the display 22. This advantageously enables a user to intuitively search through multiple different menu options.

For example, each of the graphical items 71-76 may relate to a different software application. However, it may not be possible to display all of the graphical items 71-76 on the display 22 at the same time (for example, due to the size of the display 22). In embodiments of the invention, a user may perform the hand swipe gesture to search through the graphical items 71-76, in order to find the one that he is looking for. When a desired graphical item is displayed, selection of that graphical item (for example, by providing fingertip input at the graphical item) may result in the software application being executed.

The processor 12 may control browsing across a level in the menu structure in such a way that the user perceives it to be “continuous”. The processor 12 may control the display 22 to display different graphical items after each hand swipe is detected, until all of the graphical items in a particular menu level have been displayed. When the final set of graphical items in a particular menu level are displayed, the processor 12 may also control the display 22 to display some indication that there are no further graphical items to view in that menu level. After all of the graphical items in a menu level have been displayed, detection of a further hand swipe gesture may cause the processor 12 to display the graphical items 71-73 that were initially displayed on the display 22 prior to the detection of the first hand swipe gesture.

FIG. 9C illustrates a further example of a detected elongate input pattern. In this example, the side edge 400 of the hand 100 is initially at an incline with respect to the length of the display 22. This is results in the detection of an elongate input pattern 90a that is inclined with respect to the length of the display 22.

The hand 100 is moved in this example by rotating the wrist. The dotted line designated by the reference numeral 90b illustrates the position of the elongate input pattern at a later instance in time. The arrows 95a and 95b indicate that the direction of movement of the elongate input pattern 90a, 90b remains perpendicular to the length L of the elongate input pattern as the elongate input pattern moves.

FIG. 9D illustrates an example in which the elongate input pattern 90c comprises a first elongate portion 94c separated from a second elongate portion 92c by a distance D.

The first elongate portion 94c is produced due to input provided by the side surface 106 of the little finger 105. The second elongate portion 92c is produced due to input provided by the side surface 107 of the metacarpal region 110 of the hand 100. In this example, the side surface 106 of the little finger 105 is inclined with respect to the side surface 107 of the metacarpal region 110 (by means of the metacarpophalangeal joint 115). Consequently, a portion of the side surface 106 of the little finger 105 and/or a portion of the side surface 107 of the metacarpal region 110 does not contact the display 22. The arrow 95c indicates the direction of movement of the elongate input pattern 90c.

It will be appreciated by those skilled in the art that the elongate input pattern may take a form that is different to those illustrated in FIGS. 9B, 9C or 9D. In some embodiments of the invention, the elongate input pattern may merely consist of the first elongate portion 94c (corresponding to a side surface 106 of the little finger 105) or the second elongate portion 92c (corresponding to a side surface 107 of the metacarpal region). Also, the elongate input pattern may be arcuate in nature, if metacarpophalangeal joint 115 and/or interphalangeal joints 115, 125, 135 are bent when the side edge 400 of the hand 100 contacts the display 22.

A method according to embodiments of the invention will now be described in relation to FIG. 10. Prior to block 600 in FIG. 10, the processor 12 controls the display 22 to display content in the form of the graphical items 71-73 illustrated in FIGS. 6A and 7A and discussed above.

The touch sensitive display 22 responds to user input by detecting an input pattern at an instance in time. The touch sensitive display 22 provides the input pattern to the processor 12.

At block 600 of FIG. 10, the processor 12 processes the input pattern to discriminate between a fingertip input pattern 80 (such as that illustrated in FIG. 9A) or an elongate input pattern 90, 90a, 90c (such as those illustrated in FIGS. 9B to 9D). Processing an input pattern detected at an instance in time enables the processor 12 to determine the spatial size and/or shape of the input provided by the user at a particular instance in time.

The processor 12 may analyze the input pattern to perform the discrimination. For example, the processor 12 may analyze the input pattern by comparing one or more characteristics of the detected input pattern with one or more stored reference characteristics 19. For example, the processor 12 may analyze the input pattern to determine whether it has any of the characteristics of the elongate input patterns 90, 90a, 90c described above, and/or any of the characteristics of the fingertip input pattern 80 described above.

If the processor 12 discriminates that the detected input pattern corresponds with the fingertip input pattern 80, the method proceeds along arrow 602 to block 604. If the processor 12 discriminates that the input pattern corresponds with the elongate input pattern 90, 90a, 90c, the method proceeds along arrow 606 to block 608.

At block 604 of FIG. 10, the processor 12 performs a first action after discriminating that the input pattern corresponds with the fingertip input pattern. The first action may comprise controlling the display 22 to display content, such as one or more graphical items. An example of this is described above in relation FIGS. 6A and 6B, in which the user provides fingertip input to select the first graphical item 71.

At block 608 of FIG. 10, the processor 12 performs a second action after discriminating that the input corresponds with the elongate input pattern. The second action is different to the first action. The second action may comprise controlling the display 22 to display content, such as one or more other graphical items. An example of this is described above in relation to FIGS. 7A to 7D.

In some embodiments of the invention, the processor 12 may perform the second action after determining that the input pattern (corresponding with the elongate pattern) is moving across the display 22. For instance, the processor 12 may determine that the input pattern is moving by determining that the input pattern is at different positions on the display 22 at different instances in time (as described above).

References to ‘a tangible computer-readable storage medium’, ‘a computer program product’, a ‘computer’, and a ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the FIG. 10 may represent steps in a method and/or sections of code in the computer program 16. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. For example, the user may move his hand in the opposite direction to that illustrated in FIGS. 7A to 7D when providing input using the side edge 400 of his hand 100, such that the palmar surface 200 of the hand 100 is the leading surface of the movement.

An example is described above in which the first graphical item 71 relates to “messaging”, the second graphical item 72 relates to “contacts” and the third graphical item 73 relates to “settings”. It should be appreciated that, in other embodiments of the invention, the graphical items 71, 72, 73 may not relate to “messaging”, “settings” and “contacts”. For example, the each graphical item 71, 72, 73 may relate to media content. In this regard, each graphical item 71, 72, 73 may relate to an individual file containing audio, video or audiovisual content.

In this example, detection of a fingertip tip input pattern 80 at a graphical item 71, 72, 73 causes the processor 12 to control playback of the related media content. Detection of an elongate input pattern 90 may cause the processor 12 to display further graphical items 74-76, each of which relate to further media content. This enables a user to browse through his media content, for example by swiping the side edge 400 of his hand 100 across the display 22.

In exemplary embodiments of the invention described above, detection of an elongate input pattern 90 when the first, second and third graphical items 71-73 are displayed on the display 22 causes the processor 12 to control the display 22 to display further graphical items 74-76 at the same level in a hierarchical menu structure. In alternative embodiments of the invention, the processor 12 may change the level of the menu structure that is displayed on the display 22 in response to detection of an elongate input pattern 90. In these embodiments of the invention, the further graphical items 74-76 displayed after the detection of the elongate input pattern 90 may, for example, be part of a higher level in the menu structure than the first, second and third graphical items 71-73. In other words, detection of the elongate input pattern 90 causes a de-selection of a previously selected graphical item, causing graphical items from a higher level in the menu structure to be displayed.

In some implementations, the processor 12 may be configured to perform different functions in dependence upon the direction of a hand swipe gesture. For example, the processor 12 may cause different graphical items to be displayed depending upon whether a user swipes his hand 100 from right to left across the display 22 or from left to right across the display 22. Detection of a hand swipe gesture in a vertical direction (from a lower part of the display 22 to an upper part of the display 22, or vice versa) may cause the processor 12 to display graphical items from a different level in the menu structure. For example, detection of a hand swipe gesture from a lower part of the display 22 to an upper part of the display 22 may cause the processor 12 to display graphical items from a higher level in the menu structure.

In some embodiments of the invention, it is not necessary for the user to move his hand across the display 22 to cause the processor 12 to perform the “second action” referred to in block 608 of FIG. 10. In these embodiments, the user may merely place the side edge 400 of his hand on the display 22 (for example, by performing a “chopping gesture”),

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
at least one processor; and
at least one memory storing computer program instructions configured, working with the at least one processor, to cause the apparatus at least to perform:
processing an input pattern, detected at an instance in time by a touch sensitive display, to discriminate between a fingertip input pattern and an elongate input pattern;
performing a first action after discriminating that the input pattern corresponds with the fingertip input pattern; and
performing a second action after discriminating that the input pattern corresponds with the elongate input pattern, wherein the second action is different to the first action.

2. An apparatus as claimed in claim 1, wherein the computer program instructions are configured, working with the at least one processor, to cause the apparatus to perform: after determining that an input pattern corresponding with the elongate input pattern is moving across the touch sensitive display, performing the second action.

3. An apparatus as claimed in claim 2, wherein the computer program instructions are configured, working with the at least one processor, to cause the apparatus to perform: determininge that the input pattern, corresponding with the elongate input pattern, is moving by determining that the input pattern is at different positions on the touch sensitive display at different instances in time.

4. An apparatus as claimed in claim 2, wherein the direction of movement of the input pattern, corresponding with the elongate input pattern, is substantially perpendicular to its length.

5. An apparatus as claimed in claim 2, or wherein the moving input pattern, corresponding with the elongate input pattern, is detected by the touch sensitive display in response to a user moving a side edge of a hand across the touch sensitive display.

6. An apparatus as claimed in claim 5, wherein the side edge of the hand includes a surface conjoining the palmar surface of the hand and the dorsal surface of the hand.

7. An apparatus as claimed in claim 6, wherein the surface includes a portion of the metacarpal region of the hand.

8. An apparatus as claimed in claim 6, wherein the side edge of the hand includes a portion of the little finger of the hand.

9. An apparatus as claimed in claim 1, wherein performing the first action comprises controlling the touch sensitive display to display first content, and performing the second action comprises controlling the touch sensitive display to display second content.

10. An apparatus as claimed in claim 1, wherein the computer program instructions are configured, working with the at least one processor, to cause the apparatus to perform: controlling the touch sensitive display to display at least one selectable graphical item, and, controlling, in response an input pattern corresponding with the fingertip input pattern being detected by the touch sensitive display, the touch sensitive display to display at least one further selectable graphical item.

11. An apparatus as claimed in claim 10, wherein the computer program instructions are configured, working with the at least one processor, to cause the apparatus to perform: controlling, in response to detecting an input pattern corresponding with the elongate input pattern, the touch sensitive display to display one or more other graphical items, different from the at least one further selectable graphical item.

12. An apparatus as claimed in claim 1, the computer program instructions are configured, working with the at least one processor, to cause the apparatus to perform: discriminatinge between the fingertip input pattern and the elongate input pattern by comparing at least one characteristic of the input pattern with at least one reference characteristic stored in the at least one memory.

13. An apparatus as claimed in claim 1, wherein in order for the input pattern to correspond with the elongate input pattern, the length of the input pattern is at least three times larger than the width of the input pattern.

14. A hand portable electronic device comprising the apparatus as claimed in claim 1, and the touch sensitive display.

15. A method, comprising:
processing an input pattern, detected at an instance in time by a touch sensitive display, to discriminate between a fingertip input pattern and an elongate input pattern;
performing a first action after discriminating that the input pattern corresponds with the fingertip input pattern; and
performing a second action after discriminating that the input pattern corresponds with the elongate input pattern, wherein the second action is different to the first action.

16. A method as claimed in claim 15, wherein the second action is performed after determining that an input pattern, corresponding with the elongate input pattern, is moving across the touch sensitive display.

17. (canceled)

18. A method as claimed in claim 16, wherein the direction of movement of the input pattern, corresponding with the elongate input pattern, is substantially perpendicular to its length.

19. A method as claimed in claim 16, wherein the moving elongate input pattern, corresponding with the elongate input pattern, is detected by the touch sensitive display in response to a user moving a side edge of a hand across the touch sensitive display.

20. (canceled)

21. (canceled)

22. (canceled)

23. A non-transitory computer readable medium storing a computer program comprising computer program instructions that are configured, working with at least one processor, to cause an apparatus at least to perform:
processing an input pattern, detected at an instance in time by a touch sensitive display, to discriminate between a fingertip input pattern and an elongate input pattern;
performing a first action after discriminating that the input pattern corresponds with the fingertip input pattern; and
performing a second action after discriminating that the input pattern corresponds with the elongate input pattern, wherein the second action is different to the first action.

24. A non-transitory computer readable medium as claimed in claim 23, wherein the second action is performed after determining that an input pattern, corresponding with the elongate input pattern, is moving across the touch sensitive display.

25. (canceled)

26. (canceled)

27. (canceled)

28. (canceled)

29. (canceled)

30. (canceled)

31. (canceled)

32. (canceled)

33. (canceled)
